(19) United States
(12) Patent Application Publication
(10) Pub. No.: US 2008/0125547 A1
(43) Pub. Date: May 29, 2008

(54) Polyethylene Resin Compositions Having Low Mi And High Melt Strengh

(76) Inventors: Kurt Swogger, Austin, TX (US); Pak-Wing S. Chum, Lake Jackson, TX (US); Thomas Oswald, Lake Jackson, TX (US); Stephane Costeux, Pearland, TX (US)

Correspondence Address: The Dow Chemical Company, Intellectual Property Section, P.O. Box 1967, Midland, MI, 48641-1967, US

(21) Appl. No.: 11/816,970

(22) PCT Filed: Mar. 3, 2006
(86) PCT No.: PCT/US06/07753

§ 371 Date: Aug. 23, 2007

Related U.S. Application Data
(60) Provisional application No. 60/658,961, filed on Mar. 4, 2005.

(51) Int. Cl. C08L 23/00

(52) U.S. Cl. 525/185

(57) ABSTRACT

Ethylene polymer compositions comprising a high molecular weight high density polyethylene resin and a low density polyethylene resin are disclosed, where the polymer composition has a comparatively high melt strength for a given melt index. The compositions comprise from 25 to 99 percent by weight of the composition of a linear or substantially linear polyethylene polymer having a density of at least about 0.90 g/cc, and an I21 of less than about 20; and from 1 to 25 percent by weight of the composition of a high pressure low density type polyethylene resin having a melt index (I2) less than about 5, a molecular weight distribution greater than about 10, a Mw_abs/Mw_gpc ratio (“Gr”) of at least 2.7, and a melt strength at 190° C. greater than 19.0−12.6*log10(Mi). The compositions of the present invention are particularly well suited for blown film and thermoforming applications.

This invention pertains to polyethylene compositions. In particular, the invention pertains to ethylene polymer compositions comprising a high molecular weight high density polyethylene resin and a low density polyethylene resin, where the polymer composition has a comparatively high melt strength for a given melt index. The compositions of the present invention are useful in any application where low MI and high melt strength are required, particularly where high modulus is also desired. These compositions are also of particular utility in applications were low or depressed Tan (δ) is advantageous. Thus, the compositions of the present invention are particularly well suited for blown film and thermoforming applications. The invention also pertains to a method of using the ethylene polymer compositions in various applications such as blown films, thermoformed articles, extruded pipes, blow molded articles and foams.

High Molecular Weight High Density Polyethylene (HMW-HDPE) is widely used in blown film, blow molding and thermoforming applications at least in part because of its relatively high melt strength. In the production of blown films, the resin is extruded through an annular die and the molten polymer is pulled away along the die axis in the form of an expanded bubble. After the resin cools to a set diameter, the bubble is collapsed and passes through nip rolls for further manufacturing steps. In large part thermoforming, the resin is extruded as a sheet and then formed over a mold, often with vacuum assistance. In this process, high melt strength is required to prevent premature sagging of the sheet. Resins with Tan (δ) close to 1.0 are preferred. The thermoforming operating window is the range of temperatures from the melting point up to the temperature at which Tan (δ) becomes too high or low. A wide temperature operating window is preferred.

The necessary melt strength may be obtained in high pressure low density resins such as LDPE and EVA, at moderate melt indices of 0.2-1.0 dg/min, however such resins have a maximum density of about 0.935 g/cc and therefore cannot provide the modulus required in many blown film and thermoforming applications. These resins are also well known to exhibit poor tensile properties, low scratch and mar resistance etc. Suitable performance characteristics are provided by linear and substantially linear polyethylene of sufficient density, typically greater than 0.940 g/cc. In order for linear or substantially linear polyethylene resins of high density to provide the necessary melt strength, the melt index (I₂₁) must be lowered to 8.0-13.0 dg/min in the case of blown film resins and thermoforming resins. We have found that new compositions comprising HMW-HDPE and particular grades of LDPE characterized by having very high levels of long chain branching simultaneously provide synergistically increased melt strength at the same melt index as a HMW-HDPE resin, thus allowing the film to be blown at higher rates while also reducing port-line effects in blown film and in thermoforming operations, reduce sag and provide resins with an increased thermoforming window and improved ESCR. This latter effect is particularly unexpected as conventional LDPE resins are known in the art to significantly reduce physical properties (such as dart and tear) when blended, even in relatively small amounts, into linear polyethylene.

Thus, although the inventive materials are suitable for a wide variety of uses requiring high melt strength, they have been found to be particularly suitable for blown film and thermoforming processes.

A. Blown Film Process:

It is desired to minimize any variations in the polymer thickness and/or composition, as variations can cause bubble instability and also can cause problems in downstream applications such as printing presses, laminators or bag machines. It is recognized that variations may be caused by many different factors including non-uniformity in flow distribution channels (ports and spirals) within the die, melt viscosity non-uniformity and inconsistent annular die gaps through which the polymer exits the die.

One major difficulty in using annular dies stems from the fact that annular flow requires both an inner and an outer edge. To form the inner edge, the molten polymer must flow around an object within the cavity of the melt pipe. To be uniform, this object must be fixed. To do this, the object which forms the inner edge must be attached to the rest of the die in some manner, and typically this involves placing structures connecting the inner-wall forming object with the outer wall forming pipe. These structures temporarily disrupt the flow of the molten polymer, forming separate streams, which must be recombined after passing the connecting structure. This recombination of the streams may result in “port lines”. It has been observed that the presence and severity of the port lines generally increases with increasing production speeds. Port lines create undesired variability in the film thickness and appearance and also lead to bubble instability.

Many approaches have been used to combat the formation of port lines. One approach is to simply reduce the production rates. While effective, these methods make the process less economically desirable.

Another approach is to focus on the equipment itself. These approaches focus on the die design. In blown film production, the most common die designs feature recombination techniques which employ channels which spiral around the axis of the die. These spirals overlap one another and allow the molten polymer to flow around the connecting structures recombining in an onion-like pattern as the material flows to the annular exit. The problem reported with this approach stems from the non-Newtonian flow of the polymer. To compensate for this non-Newtonian flow, the channels and connecting structures are made non uniform, however this approach cannot be adjusted to account for the variances in properties caused from variances in the polymer composition.

Other approaches for reducing or eliminating port lines include the use of certain fluorocarbon processing aids. U.S. Pat. No. 6,734,252, for example, teaches the use of an additive containing a fluorothermoplastic copolymer. While these types of processing aids may help to reduce port lines, they add cost and do not increase the bubble stability. Accordingly, improved methods of reducing port lines and increasing bubble stability for HDPE are still desired.

B. Thermoforming Process

Sheet production and thermoforming into a desired shape has been described by Moore, E. P. Jr., Polypropylene Handbook, Hanser Gardner Publications, Inc., New York, 1998, pages 333-335; McCarty, R. A., “Thermoforming of Rigid PVC Sheet”; Chapter 9, pages 439-453; Engineering with Rigid PVC-Processability and Applications; Edited by I Luis Gonez, 1984, Marcel Dekker, Inc.; King, S., “Postfabrication, Decorating and Finishing; Chapter 28; Encyclopedia of PVC, Volume 3 pages 1527-1543, 1977, Marcel Dekker, Inc.; and Florian, J.; “Practical Thermoforming-Principles and Applications, Second Edn., 1996, New York (each of these references is hereby incorporated by reference). The sheet process typically involves sheet extrusion through a slot die followed by cooling on a roll stack, conveying of sheet over rollers to a take-off nip and then cutting and stacking. Thermoforming typically involves feeding sheet into an oven, heating of sheet, forming mold placement, vacuum application, transport and cooling, completed by cutting and edge trimming. There are many desired properties to be considered in the selection of resin, depending on the end-use, such as gloss, colorability, scratch and mar resistance, environmental stress-crack resistance. Many plastics, including polyvinyl chloride (PVC), polypropylene, polystyrene and HMW-HDPE are available. The type of resin chosen will be determined by the end use application. However, the most basic requirement is that of thermoformability wherein the sheet must resist sag, draw with good gauge distribution and have sufficient breadth of forming window to facilitate the ease of control of the heating and forming process. Melt strength is an important predictor of sag resistance, with higher melt strength associated with improved sag resistance. The ideal forming temperature is considered to be in the vicinity of the temperature for which the elastic and viscous components of the complex modulus are equal, that is Tan(δ)=G″/G′=1. It is therefore desirable that Tan (δ) be in the range 0.95-1.05 over a wide temperature interval. Thus, there is a need for resins with improved melt strength and increased thermoforming operating window, especially at densities above 0.940 g/cc.

It has been discovered that the addition of a minor amount of a low density polyethylene (LDPE) having a very high melt strength to a polyethylene homopolymer or copolymer having a density greater than about 0.90 g/cc reduces the occurrence of port lines while the melt strength of the resulting blend is increased synergistically, providing increased bubble stability in the blown film process and reduced tendency to sag in the thermoforming process. It has also been found that the Tan(δ) is lowered towards 1.0 in the inventive compositions as the LDPE is added up to about 20 percent, after which the Tan(δ) increases until it reaches that of pure LDPE, the Tan(δ) of which is generally higher than that of the HMW-HDPE. This advantageous and non-linear behaviour was not expected. It is known in the art that it is desirable for thermoforming resins to have a Tan(δ) close to 1.0, thus the inventive compositions are beneficial. These compositions also exhibit improved ESCR, which is usually a desirable property in thermoforming large parts intended for heavy duty applications, such as truck bed liners, durable goods etc.

The LDPE for use in the present invention should have an MI or melt index (I₂) of less than about 5 dg/min, more preferably less than about 1 dg/min, and a melt strength (measured in cN) greater than 19.0−12.6*log₁₀(MI). The LDPE will have a molecular weight distribution (MWD) of greater than about 10 and a Mw_abs/Mw_gpc ratio (“Gr”) of at least 2.7. The LDPE will ideally be added in an amount such that it makes up from 1 to 25 percent by weight of the final composition. The polyethylene homopolymer will preferably have an I₂₁, less than about 20 dg/min.

Accordingly in one aspect, the present invention is a polymer blend comprising: from 25 to 99 percent by weight of the composition of a first component comprising a polyethylene homopolymer or copolymer having a density of at least about 0.90 g/cc, and an I₂₁ of less than about 20 dg/min; and from 1 to 25 percent by weight of the composition of a second component comprising a high pressure low density type polyethylene resin having a melt index (I₂) less than about 5 dg/min, a molecular weight distribution greater than about 10, a Mw_abs/Mw_gpc ratio (Gr) of at least 2.7, and a melt strength (in cN) greater than 19.0−12.6*log₁₀(MI).

Another aspect of the present invention is a method to improve the bubble stability in a process to make blown film from polyethylene of density greater than about 0.90 g/cc, wherein the improvement comprises blending from 1-25 percent by weight of a high pressure low density type polyethylene resin having a melt index (I₂) less than about 5 dg/min, a molecular weight distribution greater than about 10, a Mw_abs/Mw_gpc ratio (Gr) of at least 2.7, and a melt strength greater than 19.0−12.6*log₁₀(MI) with the linear or substantially linear polyethylene prior to forming the bubble. Films made with such blends are yet another aspect of the present invention.

Another aspect of the present invention is a method to reduce the tendency to sag in a process of thermoforming polyethylene sheet of density greater than about 0.90 g/cc, wherein the improvement comprises blending from 1-25 percent by weight of a high pressure low density type polyethylene resin having a melt index (I₂) less than about 5 dg/min, a molecular weight distribution greater than about 10, a Mw_abs/Mw_gpc ratio (Gr) of at least 2.7, and a melt strength greater than 19.0−12.6*log₁₀(MI) with the linear or substantially linear polyethylene prior to forming the sheet. Thermoformed articles made from such blends are yet another aspect of the invention.

It has been observed that in blends comprising a high pressure low density type polyethylene resin having a melt index (I₂) less than about 5 dg/min and greater than about 0.1, a molecular weight distribution greater than about 10, a Mw_abs/Mw_gpc ratio (Gr) of at least 2.7, and a melt strength (in cN) greater than 19.0−12.6*log₁₀(MI), and a linear or substantially linear polyethylene homopolymer or copolymer having a density greater than 0.90 g/cc, and melt index (I₂₁) less than about 20 dg/min, the melt index (I₂₁) is reduced to levels which are lower than either component by itself. At the same time the observed melt strength for the blend was noted to be higher than the additive mixing rule would suggest, thus these compositions exhibit positive melt strength synergy. Thus, another aspect of the invention is a method for increasing melt strength and/or reducing the melt index of homopolymer or copolymer polyethylene having a density greater than 0.90 g/cc, comprising blending the homopolymer polyethylene with from 1-25 percent by weight of a high pressure low density type polyethylene resin having a melt index (I₂) less than about 5 dg/min, a molecular weight distribution greater than about 10, and a melt strength (in cN) greater than 19.0−12.6*log₁₀(MI). These blends are useful in any application where low MI and high melt strength are desired and particularly in applications where it is desirable to have a high modulus. In addition to blown film applications and thermoforming applications, such materials my be useful in multilayered structures and molded articles.

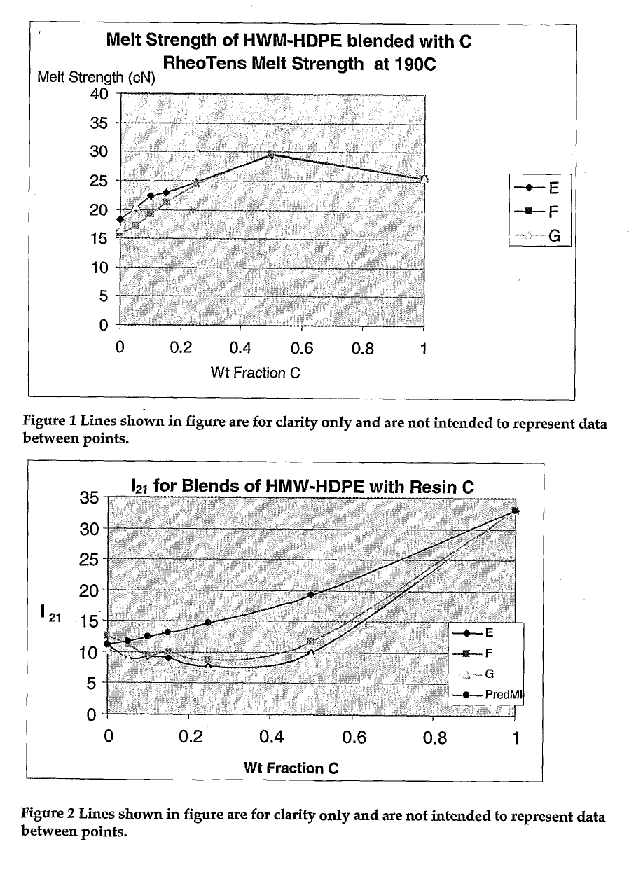

FIG. 1 is a plot of Melt strength vs. Wt fraction of Component C for resins E, F and G.

FIG. 2 is a plot of Melt index (I₂₁) vs. Wt fraction of Component C for resins E, F and G.

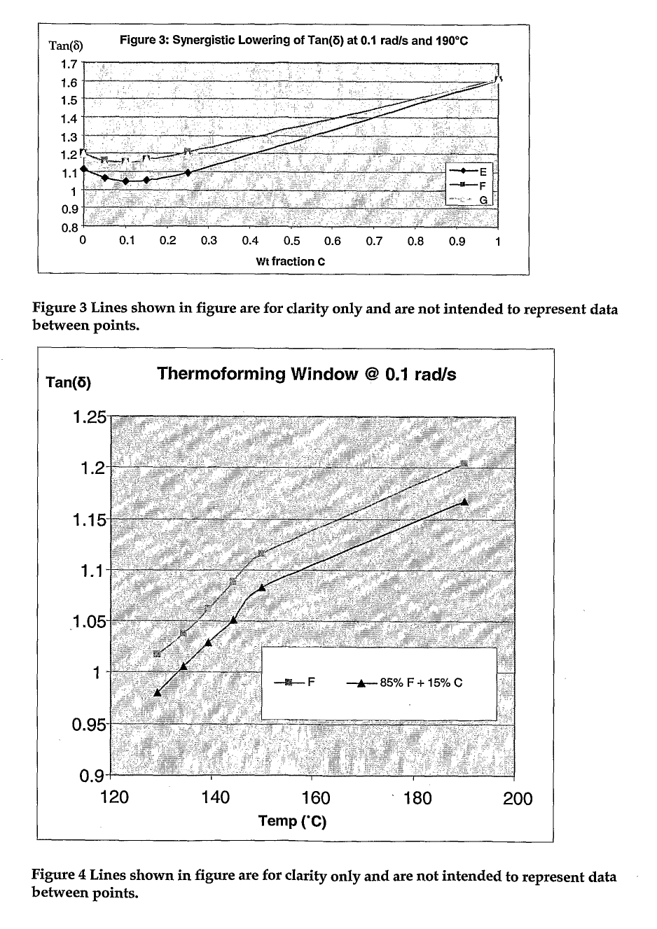

FIG. 3 is a plot of Tan (δ) vs. Wt fraction of Component C1 for resins E, F and G.

FIG. 4 is a plot of Tan (δ) vs. Temperature for 100 percent Component F and a blend of 85 percent F and 15 percent C

### DESCRIPTION OF THE PREFERRED EMBODIMENTS

The following terms shall have the given meaning for the purposes of this invention:

Tan (δ) is defined in a Dynamic Mechanical Spectroscopic measurement on a molten polymer as the tangent of the phase angle between the strain sine wave signal and the stress response. It is commonly computed as the ratio of the Loss modulus G″ and the Storage modulus G′, that is Tan(δ)=G″/G′ (see Dealy, J. M.; Wissbrun, K. F.; “Melt Rheology and its Role in Plastics Processing”, pages 60-62, Ed. Van Nostrand Reinhold, 1990, New York, hereby incorporated by reference). In the present invention, Tan(δ) is evaluated at various temperature at a frequency of 0.1 rad/s and a strain amplitude of 1 percent. In FIG. 4 the temperature is varied between 150° C. and 130° C. by steps of 5° C., and the measurement is carried out after a temperature equilibration delay of 3 minutes. The data points at 190° C. in FIG. 4 and the data in FIG. 3 were measured at a constant temperature of 190° C. in separate experiments, at 0.1 rad/s and with a strain amplitude of 2 percent.

“Melt strength” which is also referred to in the relevant art as “melt tension” is defined and quantified herein to mean the stress or force (as applied by a wind-up drum equipped with a strain cell) required to draw a molten extrudate at a haul-off velocity at which the melt strength plateaus prior to breakage rate above its melting point as it passes through the die of a standard plastometer such as the one described in ASTM D1238-E.

Melt strength values, which are reported herein in centi-Newtons (cN), are determined using a Göttfert Rheotens. The air gap—distance from the die exit to the take-up wheels—is set to 100 mm, and the wheels acceleration is 2.4 mm/s². The melt is produced by a Göttfert Rheotester 2000 at 190° C. unless otherwise specified, equipped with a 12 mm barrel and a die with flat entrance (L=30 mm and ØID=2 mm) at a piston speed of 0.265 mm/s.

Drawability was measured from the melt strength test as the velocity at which the fiber broke, measured in mm/second.

“ESCR” which is also referred to in the relevant art as “environmental stress crack resistance” was measured according to ASTM D1693 using 10 percent Igepal C0-630 in deionized water. Values quoted are estimated hours required for 50 percent of 10 samples to break using the graphical method described in ASTM1693.A1

“Sag” was measured by placing a 110 mil sheet of specimen in a 2′×3′ (60 cm×90 cm) clamp frame and placing in oven at 163±2° C. Sag was measured in inches as the downward deflection of the center of the sheet from the initial position using a light beam sensor after 160 seconds.

Density is tested in accordance with ASTM D792.

“Melt index” is tested at 190 C according to ISO 1133: 1997 or ASTM D1238: 1999; I₂ is measured with a 2.16 kg weight, I₅ and I₁₀ with 5 and 10 kg weight respectively; I₂₁ with a 21.6 kg weight. Numbers are reported in gram per 10 minutes, or dg/min.

The term “polymer”, as used herein, refers to a polymeric compound prepared by polymerizing monomers, whether of the same or a different type. The generic term polymer thus embraces the term “homopolymer”, usually employed to refer to polymers prepared from only one type of monomer as well as “copolymer” which refers to polymers prepared from two or more different monomers.

The term “LDPE” may also be referred to as “high pressure ethylene polymer” or “high pressure low density type resin” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, herein incorporated by reference).

The term “Linear PE” is defined to mean any linear, substantially linear or heterogeneous polyethylene copolymer or homopolymer. The Linear PE can be made by any process such as gas phase, solution phase, or slurry or combinations thereof. The Linear PE may consist of one or more components, each of which is also a Linear PE.

The term molecular weight distribution or “MWD” is defined as the ratio of weight average molecular weight to number average molecular weight (M_{w}/Mₙ). M_{w} and Mₙ are determined according to methods known in the art using conventional GPC.

The ratio Mw(absolute)/Mw(GPC), (“Gr”), is defined wherein Mw(absolute) is the weight average molecular weight derived from the light scattering area at low angle (such as 15 degrees) and injected mass of polymer and the Mw(GPC) is the weight average molecular weight obtained from GPC calibration. The light scattering detector is calibrated to yield the equivalent weight average molecular weight as the GPC instrument for a linear polyethylene homopolymer standard such as NBS1475.

### Details of GPC Method to Obtain MWD and Gr:

In order to determine the GPC moments used to characterize the polymer compositions, the following procedure was used:

The chromatographic system consisted of a Waters (Millford, Mass.) 150 C high temperature chromatograph equipped with a Precision Detectors (Amherst, Mass.) 2-angle laser light scattering detector Model 2040. The 15-degree angle of the light scattering detector was used for the calculation of molecular weights. Data collection was performed using Viscotek (Houston, Tex.) TriSEC software version 3 and a 4-channel Viscotek Data Manager DM400. The system was equipped with an on-line solvent degas device from Polymer Laboratories (Shropshire, UK).

The carousel compartment was operated at 140° C. and the column compartment was operated at 150° C. The columns used were 7 Polymer Laboratories 20-micron Mixed-A LS columns. The solvent used was 1,2,4 trichlorobenzene. The samples were prepared at a concentration of 0.1 grams of polymer in 50 milliliters of solvent. The chromatographic solvent and the sample preparation solvent contained 200 ppm of butylated hydroxytoluene (BHT). Both solvent sources were nitrogen-sparged. Polyethylene samples were stirred gently at 160 degrees Celsius for 4 hours. The injection volume used was 200 microliters and the flow rate was 1.0 milliliters/minute.

Calibration of the GPC column set was performed with 18 narrow molecular weight distribution polystyrene standards with molecular weights ranging from 580 to 8,400,000 which were arranged in 5 “cocktail” mixtures with at least a decade of separation between individual molecular weights. The standards were purchased from Polymer Laboratories (Shropshire, UK). The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The narrow standards mixtures were run first and in order of decreasing highest molecular weight component to minimize degradation. The polystyrene standard peak molecular weights were converted to polyethylene molecular weights using the following equation (as described in Williams and Ward, J. Polym. Sci., Polym. Let., 6, 621 (1968)):

M_{polyethylene}=A×(M_{polystyrene})^{B}

### Where M is the molecular weight, A has a value of 0.41 and B is equal to 1.0. A fourth order polynomial was used to fit the respective polyethylene-equivalent calibration points.

The total plate count of the GPC column set was performed with Eicosane (prepared at 0.04 g in 50 milliliters of TCB and dissolved for 20 minutes with gentle agitation.) The plate count and symmetry were measured on a 200 microliter injection according to the following equations:

PlateCount=5.54*(RV at Peak Maximum/(Peak width at ½ height))̂2

### Where RV is the retention volume in milliliters and the peak width is in milliliters.

Symmetry=(Rear peak width at one tenth height−RV at Peak maximum)/(RV at Peak Maximum−Front peak width at one tenth height)

Where RV is the retention volume in milliliters and the peak width is in milliliters.

The Systematic Approach for the determination of multi-detector offsets was done in a manner consistent with that published by Balke, Mourey, et. al (Mourey and Balke, Chromatography Polym. Chpt 12, (1992)) (Balke, Thitiratsakul, Lew, Cheung, Mourey, Chromatography Polym. Chpt 13, (1992)), optimizing dual detector log MW results from Dow broad polystyrene 1683 to the narrow standard column calibration results from the narrow standards calibration curve using in-house software. The molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, N.Y. (1987)). The overall injected concentration used for the determination of the molecular weight was obtained from the sample refractive index area and the refractive index detector calibration from a linear polyethylene homopolymer of 115,000 molecular weight. The chromatographic concentrations were assumed low enough to eliminate addressing 2^{nd} Virial coefficient effects (concentration effects on molecular weight).

In order to monitor the deviations over time, which may contain an elution component (caused by chromatographic changes) and a flow rate component (caused by pump changes), a late eluting narrow peak is generally used as a “marker peak”. A flow rate marker was therefore established based on the air peak mismatch between the degassed chromatographic system solvent and the elution sample on one of the polystyrene cocktail mixtures. This flow rate marker was used to linearly correct the flow rate for all samples by alignment of the air peaks. Any changes in the time of the marker peak are then assumed to be related to a linear shift in both flow rate and chromatographic slope.

To facilitate the highest accuracy of a retention volume (RV) measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flow rate (as a measurement of the calibration slope) is calculated as Equation 1. In a high-temperature SEC system, an antioxidant mismatch peak or an air peak (if the mobile phase is sufficiently degassed) can be used as an effective flow marker. The primary features of an effective flow rate marker are as follows: the flow marker should be mono-dispersed. The flow marker should elute close to the total column permeation volume. The flow marker should not interfere with the chromatographic integration window of the sample.

FlowRateEffective=FlowRateNominal*FlowMarkerCalibration/FlowMarkerObserved Equation 1

The preferred column set is of 20 micron particle size and “mixed” porosity to adequately separate the highest molecular weight fractions appropriate to the claims.

The verification of adequate column separation and appropriate shear rate can be made by viewing the low angle (less than 20 degrees) of the on-line light scattering detector on an NBS1476 high pressure low density polyethylene standard. The appropriate light scattering chromatogram should appear bimodal (very high MW peak and moderate molecular weight peak) with approximately equivalent peak heights. There should be adequate separation by demonstrating a trough height between the two peaks less than half of the total LS peak height. The plate count for the chromatographic system (based on eicosane as discussed previously) should be greater than 32,000 and symmetry should be between 1.00 and 1.12.

### Description of the Composition

The composition of matter of the present invention comprises at least two components. The first component is a polyethylene homopolymer or copolymer having a density of at least about 0.89 g/cc, preferably at least about 0.90 g/cc, more preferably at least about 0.92, most preferably above about 0.945. The first component will preferably have an I₂₁ as determined by ASTM 1238 of less than about 20 dg/min. Any type of Linear PE can be used in the blends which make up the preferred compositions of the present invention. This includes the substantially linear ethylene polymers which are further defined in U.S. Pat. No. 5,272,236, U.S. Pat. No. 5,278,272, U.S. Pat. No. 5,582,923 and U.S. Pat. No. 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The Linear PE can be made via gas-phase, solution-phase or slurry polymerization or any combination thereof, using any type of reactor or reactor configuration known in the art, with gas and slurry phase reactors being most preferred. Similarly, the catalyst system used can be any known in the art including Ziegler-Natta and Chromium based catalysts.

The first component may comprise from 75 to 99 percent of the total composition with 80 to 98 percent more preferred and 85 to 96 percent being still more preferred. In the blown film aspect of the invention the most preferred range is 93-96 percent and in the thermoforming aspect the most preferred range is 85-90 percent.

The second required component for the blends of the present invention is a high pressure low density type polyethylene resin having a melt index (I₂) less than about 5, a molecular weight distribution greater than about 10, a Gr value of at least 2.7 and a melt strength greater than 19.0−12.6*log₁₀(MI). Preferably the I₂ for the second component is at least about 0.1, and less than 1.0, with resins having an I₂ of about 0.5 being most preferred.

The molecular weight distribution of the second component is preferably greater than about 10, more preferably greater than 10.5 and most preferably greater than 11.0. The Gr value is preferably greater than 2.7, more preferably greater than 3.0 and most preferably greater than 3.5. The melt strength of the second component is greater than 19.0−12.6*log₁₀(MI), where MI represents the I₂ for the polymer. More preferably, the melt strength is greater than 20.0−13.3*log₁₀(MI) and most preferably greater than 21.1−14.0*log₁₀(MI).

This second component will comprise from at least 1 percent, to 25 percent of the total composition, more preferably from 2 to 20 percent of the composition and still more preferably from 4 to 15 percent of the composition. In the blown film aspect of the invention, the most preferred range is 4-7 percent of the composition and in the thermoforming aspect, the most preferred ranged is 10-15 percent of the composition. It should be understood that the total amount of the first and second components does not necessarily have to equal 100 percent.

The molecular architecture of the preferred high pressure low density ethylene polymer composition is believed to be related to the physical rheological properties of the final composition. Without intending to be bound to theory, it is believed that the LDPE portion of the preferred blends for the present invention can supply high molecular weight, highly branched structure which leads to the unique combination of rheology and molecular architecture. It should be understood, however that the high molecular weight highly branched portion needs not come from a high pressure low density resin, and other processes such as those described in WO 02/074816, may be applicable.

Such an LDPE can be made in an autoclave reactor (optionally configured with a series tube reactor) with chilled ethylene feed below 35° C. operating in single phase mode with three or more zones at an average reactor temperature of approximately 240° C.

The composition of the present invention may also include LDPE/LDPE blends where one of the LDPE resins has a relatively higher melt index and the other has a lower melt index and is more highly branched. The component with the higher melt index can be obtained from a tubular reactor, and a lower MI, higher branched, component of the blend may be added in a separate extrusion step or using a parallel tubular/autoclave reactor in combination with special methods to control the melt index of each reactor, such as recovery of telomer in the recycle stream or adding fresh ethylene to the autoclave (AC) reactor, or any other methods known in the art.

Suitable high pressure ethylene polymer compositions for use in preparing the inventive extrusion composition include low density polyethylene (homopolymer), ethylene copolymerized with at least one α-olefin for example butene, and ethylene copolymerized with at least one αβ-ethylenically unsaturated comonomers, for example, acrylic acid, methacrylic acid, methyl acrylate and vinyl acetate. A suitable technique for preparing useful high pressure ethylene copolymer compositions is described by McKinney et al. in U.S. Pat. No. 4,599,392, the disclosure of which is incorporated herein by reference.

While both high pressure ethylene homopolymers and copolymers are believed to be useful in the invention, homopolymer polyethylene is generally preferred.

### Preparation of the Compositions

The preferred polymer extrusion compositions of this invention can be prepared by any suitable means known in the art including preferred methods such as tumble dry-blending, weight feeding, solvent blending, melt blending via compound or side-arm extrusion, or the like as well as combinations thereof.

The compositions of the present invention can also be blended with other polymer materials, such as polypropylene, high pressure ethylene copolymers such as ethylvinylacetate (EVA) and ethylene acrylic acid and the like, and ethylene-styrene interpolymers. In addition, materials such as mineral fillers and fiberglass and/or cellulose or other plant fiber products, can also be added. These other materials can be blended with the inventive composition to modify processing, physical properties such as modulus, film strength, heat seal, or adhesion characteristics as is generally known in the art.

Both of the required components of the blends of the current invention can be used in a chemically and/or physically modified form to prepare the inventive composition. Such modifications can be accomplished by any known technique such as, for example, by ionomerization and extrusion grafting.

Additives such as antioxidants (for example, hindered phenolics such as Irganox® 1010 or Irganox® 1076 supplied by Ciba Geigy), phosphites (for example, Irgafos® 168 also supplied by Ciba Geigy), cling additives (for example, PIB), Standostab PEPQ™ (supplied by Sandoz), pigments, colorants, fillers, and the like can also be included in the ethylene polymer extrusion composition of the present invention at levels typically used in the art to achieve their desired purpose. The article made from or using the inventive composition may also contain additives to enhance antiblocking and coefficient of friction characteristics including, but not limited to, untreated and treated silicon dioxide, talc, calcium carbonate, and clay, as well as primary, secondary and substituted fatty acid amides, chill roll release agents, silicone coatings, etc. Other additives may also be added to enhance the anti-fogging characteristics of, for example, transparent cast films, as described, for example, by Niemann in U.S. Pat. No. 4,486,552, the disclosure of which is incorporated herein by reference. Still other additives, such as quaternary ammonium compounds alone or in combination with ethylene-acrylic acid (EAA) copolymers or other functional polymers, may also be added to enhance the antistatic characteristics of coatings, profiles and films of this invention and allow, for example, the packaging or making of electronically sensitive goods.

Multilayered constructions comprising the inventive composition can be prepared by any means known including blown and cast film, co-extrusion, laminations and the like and combinations thereof.

The ethylene polymer compositions of this invention are ideally suited for use in blown film applications, but can be used in any application where low melt index and high melt strength are desired. Thus, the composition of the present invention can be used for molded articles; in particular they are suitable for large part thermoforming. Furthermore films made from the composition of the present invention may be used in multilayer structures. When the inventive composition is used in multilayered constructions, substrates or adjacent material layers can be polar or nonpolar including for example, but not limited to, paper products, metals, ceramics, glass and various polymers, particularly other polyolefins, and combinations thereof.

### EXAMPLES

Blown film examples: A description of all of the resins used in the Examples is presented in Table 1. All resins were stabilized with antioxidant.

TABLE 1

| | | Density | MI (I₅) | I₂₁ | I₂ | |
|---|---|---|---|---|---|---|
| Resin | comonomer | g/cc | g/10 min | g/10 min | g/10 min | Processing Aid |
| A (HDPE-7997 (Dow)) | hexene | 0.949 | 0.35 | 10.5 | N/A | 660 ppm |
| | | | | | | Fluoropolymer |
| | | | | | | Viton FF-22 |
| B (HDPE-7997 (Dow)) | hexene | 0.949 | 0.35 | 10.5 | N/A | 0 |
| C (LDPE 662i (Dow)) | none | 0.919 | N/A | 33.0 | 0.47 | 0 |
| D (HDPE OPP HF-150 | hexene | 0.948 | 0.4 | 10 | N/A | 2000 ppm CA/Zn |
| (Braskem)) | | | | | | Stearate |

Comparative Example 1 of the present invention was prepared with 100 percent of Resin A. Comparative Example 2 was prepared with 100 percent of Resin D. Comparative Example 3 was prepared with 100 percent of Resin B. Example 4 was prepared with 2 percent Resin C and 98 percent Resin B. Example 5 was prepared with 5 percent Resin C and 95 percent Resin B, Example 6 was prepared with 10 percent Resin C and 90 percent Resin B. Example 7 was prepared with 15 percent Resin C and 85 percent Resin B. The Melt Index I₅ of each of the Examples was measured according to ASTM method D1238 using a weight of 5 kg at 190° C. Except for sheet used in sag tests, blended examples were prepared using a twin screw Leistritz Model micro-18 having six zones, a screw diameter=18 mm, L/D=30, with the following screw configuration:

The heated zones settings were set at 150, 180, 200, 215, and 215° C. with the die set at 215° C. The samples were dry blended and fed into the extruder through a feed throat at the first GFA-2-30-90 element. The feed zone was cooled by chilled water (20° C.) to prevent premature melting and bridging of the feed throat.

The dry blended samples were fed to the co-rotating twin screws turning at a screw peed of 250 rpm at a rate of 3.5-4.5 lb/hr. through the feed throat by a twin screw auger.

Melt Strength was measured using a Rheotens device from Göttfert. The wheels acceleration was set to 2.4 mm/s². The melt was fed to the Rheotens at 210° C. by a Göttfert capillary rheometer at a shear rate of 38.2 s⁻¹ (L=30 mm and ØID=2 mm).

The results of these Examples are presented in Table 2.

TABLE 2

| | | | drawability |
|---|---|---|---|
| Example | I₅ | MS@210° C. (cN) | (mm/sec) |
| C1 | 0.340 | 16.6 | 97.6 |
| C2 | 0.355 | 15.8 | 97.6 |
| C3 | 0.386 | 16.8 | 101.2 |
| 4 | 0.359 | 17.7 | 118 |
| 5 | 0.326 | 20.2 | 112 |
| 6 | 0.294 | 22.2 | 82.6 |
| 7 | 0.287 | 23.6 | 64 |

Thermoforming Examples:

A description of all resins used in these examples is given in Table 3. Sheet samples for sag testing were prepared by dry-blending components where required and extruding via a 2.5″ (6.35 cm) single screw extruder (L/D=30.7; pitch=2.5″; Helix angle=17.7°). Extruder temperature zones were set to 210, 220, 230, 240° C., the die was set to 240° C. and the extrusion rate was 21.6″/minute (54 cm/min).

TABLE 3

| | | | | | | MS@190 C. | | | |
|---|---|---|---|---|---|---|---|---|---|
| Resin | I21 | I₅ | I₂ | Density | Gr | (cN) | ESCR^{†} | Sag (in) | Tan(δ)^{‡} |
| E (HDPE - GA50-100 (Solvay)) | 11.2 | 0.41 | N/A | 0.9497 | N/A | 18.2 | 24 | 2.75 | 1.114 |
| F (HDPE - DGDA5110 (Dow)) | 12.6 | 0.54 | N/A | 0.9468 | N/A | 15.8 | 36 | 3.5 | 1.205 |
| G (HDPE - DMDA6147 (Dow)) | 10.2 | 0.43 | N/A | 0.9490 | N/A | 16.6 | 364 | N/A | 1.199 |
| C (LDPE - 662i (Dow)) | 33.0 | N/A | 0.47 | 0.9190 | 3.7 | 25.5 | N/A | N/A | 1.609 |

A description of the composition of inventive blends is given in Table 4.

TABLE 4

| | | | | | | | MS@190 C. | | | |
|---|---|---|---|---|---|---|---|---|---|---|
| ID | Comp1 | Comp2 | Wt %_1 | Wt %_2 | MI (I₂₁) | MI (I₅) | (cN) | ESCR† | Sag (in) | Tan(δ)‡ |
| 8 | E | C | 95 | 5 | 8.88 | 0.34 | 20.3 | N/A | N/A | 1.065 |
| 9 | E | C | 90 | 10 | 9.20 | 0.34 | 22.3 | N/A | N/A | 1.045 |
| 10 | E | C | 85 | 15 | 9.10 | 0.34 | 23.0 | N/A | N/A | 1.054 |
| 11 | E | C | 75 | 25 | 7.65 | 0.36 | 24.9 | N/A | N/A | 1.092 |
| 12 | F | C | 95 | 5 | 11.2 | 0.43 | 17.1 | 36 | 3.0 | 1.161 |
| 13 | F | C | 90 | 10 | 9.41 | 0.39 | 19.1 | 36 | 2.5 | 1.157 |
| 14 | F | C | 85 | 15 | 9.99 | 0.46 | 21.2 | 32 | 2.5 | 1.167 |
| 15 | F | C | 75 | 25 | 8.75 | 0.45 | 24.4 | 594 | N/A | 1.208 |
| 16 | G | C | 95 | 5 | 8.86 | 0.38 | 20.5 | N/A | N/A | 1.144 |
| 17 | G | C | 90 | 10 | 7.85 | 0.33 | 24.7 | N/A | N/A | 1.153 |
| 18 | G | C | 85 | 15 | 7.26 | 0.31 | 27.3 | NF | N/A | 1.169 |
| 19 | G | C | 75 | 25 | 7.35 | 0.34 | 30.1 | N/A | N/A | 1.190 |

^{†}N/A = Not tested;
NF no failure after 1000 hrs.

A plot of Melt strength vs. Wt fraction Component C for Examples 8-19 is shown in FIG. 1. A plot of Melt index (I₂₁) vs. Wt fraction Component C for Examples 8-19 is shown in FIG. 2. This plot also demonstrates the synergistic reduction of melt index by comparison with values calculated using the log relationship (log(MI)=f*log(MI_C)+(1−f)*log(MI_X) where f is the weight fraction of component C. MI_C is the melt index of component C and MI_X is the melt index of the appropriate linear component E, F, or G. A plot of Tan(δ) vs. Wt fraction Component C for Examples 8-19 is shown in FIG. 3 These plots demonstrate the advantageously synergistic effect of the blends of the present invention (that is the measured property deviates from the value a simple weight fraction mixing rule would predict and is so intense that the measured properties for certain compositions are either higher or lower than either of the two blend components. FIG. 4 shows that the thermoforming operating window is increased upon adding 15 percent of C to F in a stepped temperature ramp experiment at a shear rate of 0.1 rad/s.

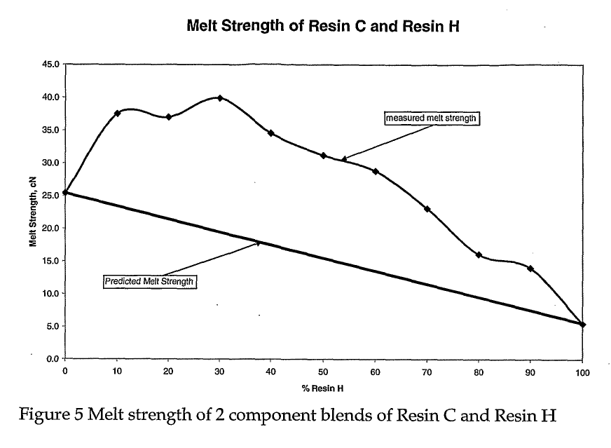

Another series of blends was prepared with varying amounts of Resin C together with Resin H, which is a linear low density polyethylene (copolymerized with 1 octene) having a density of 0.920 g/cc and an I₂ of 1.0 g/10 min. The melt strength of these blends was measured using a Göttfert Rheotens at 190° C. These results are presented in Table 5 and graphically in FIG. 5.

TABLE 5

| Run # | % Resin C | % Resin H | Melt strength (cN) |
|---|---|---|---|
| 20 | 100 | 0 | 25.4 |
| 21 | 90 | 10 | 37.5 |
| 22 | 80 | 20 | 37.0 |
| 23 | 70 | 30 | 39.9 |
| 24 | 60 | 40 | 34.5 |
| 25 | 50 | 50 | 31.2 |
| 26 | 40 | 60 | 28.8 |
| 27 | 30 | 70 | 23.1 |
| 28 | 20 | 80 | 16.1 |
| 29 | 10 | 90 | 14.0 |
| 30 | 0 | 100 | 5.5 |

As seen in FIG. 5, the blends of the present invention exhibit higher melt strength than would be expected from simply blending the two components.

Thermoforming Sheets

Sheets, 75 mil thick, were made on a conventional polyolefins extrusion sheet line, equipped with a roller stack, which was equipped with an embossing roller. Sheet properties: sag, shrinkage, drape and surface retention were qualitatively assessed.

For the thermoforming process, the sheet was clamped into a shuttle and heated for one minute using IR heaters. The sheet was then lowered onto an automotive floor mat mould and vacuum moulded for one minute. All samples were run at similar conditions.

Additional Resins

Resin I-1085 is an ethylene-butene copolymer with a melt index (I₂) of 0.85 g/10 min (ASTM D1238, 190° C./2.16 kg), a flow rate (I₂₁) of 26 g/10 min (ASTM D1238, 190° C./21.60 kg) and a density of 0.8840 g/cc (ASTM D 792).

Resin J-526A is a low density polyethylene resin with a melt index (I₂) of 1.00 g/10 min (ASTM D1238, 190° C./2.16 kg) and a density of 0.992 g/cc (ASTM D 792).

Resin K-132I is a low density polyethylene resin with a melt index (I₂) of 0.22 g/10 min (ASTM D1238, 190° C./2.16 kg) and a density of 0.921 g/cc (ASTM D 792).

Resin M-8623 is a high impact polypropylene copolymer with a melt flow rate (I₂) of 1.50 g/10 min (ASTM D1238, 230° C./2.16 kg) and a density of 0.902 g/cc (ASTM D 792).

Resin N-8100G is an ethylene-octene copolymer with a melt flow rate (I₂) of 1.0 g/10 min (ASTM D1238, 190° C./2.16 kg), a melt flow ratio (I₁₀/I₂) of 7.6 (ASTM D 1238), and a density of 0.870 g/cc (ASTM D 792).

In this experiment, simple blends of polymer were made as per Table 6, and then the sag, shrinkage, drape and surface retention were observed qualitatively. These observations are included in Table 6

TABLE 6

| | | | Resin | | | | | |
|---|---|---|---|---|---|---|---|---|
| | Resin I - | Resin J - | K - | Resin C - | | | | Surface |
| Run* # | 1085 | 526A | 132I | 662I | Sag | Shrinkage | Drape | Retention |
| 31 | 100 | | | | High | Low | N/A | N/A |
| 32 | 80 | 20 | | | Good | Good | Good | low |
| 33 | 80 | | 20 | | Good | Good | Good | Good |
| 34 | 80 | | | 20 | Low | Low | low | Excellent |

*Five replicates were made of each run

The sheet made with 100% Resin I had very poor thermoforming properties. The sheet ripped during the heat phase of the experiment. The formulation with Resin C had the best surface embossing retention and the lowest sag of the formulations run.

These experiments were repeated with the following resins:

TABLE 7

| | Resin | Resin | Resin J - | Resin K - | Resin | Resin N - |
|---|---|---|---|---|---|---|
| *Run # | I - 1085 | M - 8623 | 526I | 132I | C - | 8100G |
| 35 | 50 | 25 | 25 | | | |
| 36 | 50 | 25 | | 25 | | |
| 37 | 50 | 25 | | | 25 | |
| 38 | 25 | 25 | 25 | | | 25 |
| 39 | 25 | 25 | | | 25 | 25 |

*Each polymer system also contained 10% CaCO3 and carbon black for pigmentation

TABLE 8

| | | | | Surface |
|---|---|---|---|---|
| Run # | Sag | Shrinkage | Drape | Retention |
| 35 | Good | Good | Good | Low |
| 36 | Good | Good | Good | Good |
| 37 | Low | Low | Low | Excellent |
| 38 | Good | Good | Good | Low |
| 39 | Low | Low | Low | Excellent |

Run # 37 and #39 had very good overall thermoforming performance. Both sheets had excellent retention of the textured surface. The sheet produced from formula #39 had a very soft, rubber-like feel. Runs #35 and #38 had low retention of the sheet surface texture after thermoforming.

TABLE 9

| | Resin | Resin | | | | | |
|---|---|---|---|---|---|---|---|
| | I - | M - | Resin | | | | Surface |
| *Run # | 1085 | 8623 | C | Sag | Shrinkage | Drape | Retention |
| 40 | 50 | 25 | 25 | Low | Low | Low | Excellent |
| 41 | 55 | 25 | 20 | Low | Low | Low | Excellent |
| 42 | 60 | 25 | 15 | Low | Low | Low | Excellent |
| 43 | 65 | 25 | 10 | Medium | Medium | Medium | Good |
| 44 | 75 | 25 | 0 | High | High | High | Low |
| 45 | 45 | 30 | 25 | Low | Low | Low | Excellent |
| 46 | 55 | 30 | 15 | Low | Low | Low | Excellent |

*Each polymer system also contained 10% CaCO3 and carbon black for pigmentation

Additional experiments were conducted to evaluate the effectiveness of dicumyl peroxide in reducing surface gloss.

TABLE 10

| | Resin I - | Resin M - | | **Dicumyl | | |
|---|---|---|---|---|---|---|
| *Run # | 1085 | 8623 | Resin C | Peroxide | | Gloss |
| 47 | 50 | 25 | 20 | 0 | | High |
| 48 | 50 | 25 | 20 | 300 | ppm | Medium |
| 49 | 50 | 25 | 20 | 900 | ppm | Low |
| 50 | 50 | 25 | 20 | 1200 | ppm | Low |

*Each polymer system also contained 10% CaCO3 and carbon black for pigmentation
**added as Luperox PP20 which is a 20% concentrate

The run/formulation #47 was found to have a very high gloss surface. The addition of small amounts of dicumyl peroxide significantly reduced the surface gloss without affecting the performance of the product. Accordingly for some applications it may be preferred to include at least 100 ppm, 300 ppm, 900 ppm, or even 1200 ppm dicumyl peroxide.

The use of the high pressure low density type polyethylene resin of the present invention was found to significantly improve the thermoforming properties of polyolefin systems. In particular, the use of this resin resulted in the best retention of the sheets textured surface. Dicumyl peroxide was also effective in reducing the surface gloss of the thermoformed sheet.

We claim:

1. A composition comprising:
a. from 25 to 99 percent by weight of the composition of a linear or substantially linear polyethylene polymer having a density of at least about 0.90 g/cc, and an I₂₁ of less than about 20; and
b. from 1 to 25 percent by weight of the composition of a high pressure low density type polyethylene resin having a melt index (I₂) less than about 5, a molecular weight distribution greater than about 10, a Mw_abs/Mw_gpc ratio (Gr) of at least 2.7, and a melt strength at 190° C. greater than 19.0−12.6*log₁₀(MI).

2. The composition of claim 1 wherein component a) has a density of at least about 0.92.

3. The composition of claim 2 wherein component a) has a density if at least about 0.945.

4. The composition of claim 1 wherein component b) has a melt index (I₂) greater than about 0.1, less than about 1.0, Gr greater than about 3.0 and melt strength (190° C.) greater than 20.0−13.3*log₁₀(MI)

5. The composition of claim 1 wherein component b) has a melt index greater than about 0.2 and less than about 1.0, Gr greater than about 3.5 and melt strength (190° C.) greater than 21.1−14.0*log₁₀(MI).

6. The composition of claim 1 wherein component b) comprises from 2 to 20 percent by weight of the composition.

7. The composition of claim 6 wherein component b) comprises from 4 to 15 percent by weight of the composition.

8. The composition of claim 6 wherein component b) comprises from 4 to 7 percent by weight of the composition.

9. The composition of claim 6 wherein component b) comprises from 10 to 15 percent by weight of the composition.

10. Film made using composition in claim 1.

11. Film made using the composition of claim 8.

12. Thermoformed article made using composition in claim 1.

13. Thermoformed article made using the composition of claim 9.

14. Composition of claim 1 where Tan(δ), measured at 0.1 rad/s is at least 0.95 but no more than 1.05 over a temperature span of at least 15° C. where the temperature span is above the melting point of the composition.

15. Composition of claim 1 where the melt index (I₂) of the composition is no more than about 0.75 dg/min.
